(19) United States
(12) Patent Application Publication
(10) Pub. No.: US 2020/0076593 A1
(43) Pub. Date: Mar. 5, 2020

(54) SYSTEMS AND METHODS FOR ENCRYPTION OF VIRTUAL FUNCTION TABLE POINTERS

(71) Applicant: Zeus SW Defender, LLC, Lexington, MA (US)

(72) Inventors: Changwoo Pyo, Seoul (KR); Damho Lee, Seoul (KR)

(21) Appl. No.: 16/558,120

(22) Filed: Sep. 1, 2019

Related U.S. Application Data
(60) Provisional application No. 62/726,442, filed on Sep. 4, 2018.

(51) Int. Cl. H04L 9/08; G06F 3/06; G06F 21/60

(52) U.S. Cl. CPC H04L 9/0869; G06F 3/0623; H04L 9/0894; G06F 3/0673; G06F 21/602; G06F 3/0659

(57) ABSTRACT

The present disclosure presents systems and methods for virtual function table pointer encryption. Specifically, the systems and methods prevent outside attacks by encrypting the virtual function table pointers and further focus on encryption and decryption using keys differing among classes. The system includes a control unit, a memory management unit, a memory unit, a random key generation unit and a key storage unit. The control unit issues commands generating a key for encryption of the virtual function table pointer. The memory management unit generates a class ID from the class name. The memory unit stores the class name and the generated ID in a class ID table. The random key generation unit receives a command and generates an encryption key, and the key storage unit stores the class ID transmitted from the memory unit and the encryption key transmitted from the random key generation unit in the key storage unit.

### CROSS-REFERENCE TO RELATED APPLICATIONS

This application claims the benefit of U.S. Provisional Application No. 62/726,442, filed Sep. 4, 2018. The entire content of that application is hereby incorporated herein by reference.

### FIELD

The present disclosure relates to systems and methods for encryption of virtual function table pointers. Specifically, the systems and methods prevent attacks that compromise the virtual function table pointers by encrypting and decrypting the virtual function table pointers of objects. The encryption keys for encryption differ with others depending on the class to which the objects belong.

### BACKGROUND

The programming language C++ is defined as an object-oriented extension of the programming language C. If a class defines a virtual function, a virtual function table pointer is installed at compile-time. The virtual function table is an array of the addresses of virtual functions. The table cannot be corrupted since it resides in read-only memory area.

However, the virtual function table pointer can be compromised by outside attacks since the table pointer is in writable data memory. Outside attackers build a counterfeit virtual function table made of addresses of gadgets in data area by injecting the address through input. Then, the virtual function table pointer is set to the address of the faked table. When the counterfeit virtual function address is referenced by call or branch instructions, the attack starts.

Encryption of virtual function table pointers can prevent attacks from compromising the pointer in the objects. If the pointer is encrypted and compromised by an outside attack, the attack cannot occur but fail because the decrypted pointer outputs an unexpected value when the pointer is referenced to invoke a virtual function of the table.

However, when every virtual function pointer depends on a single encryption key, objects are exposed to a pointer corruption attack using the bug of use-after-free. A pointer to a destroyed object may refer to a new object constructed at the same location. If the encryption relies on the single key, the key for the virtual function table pointer for the destroyed object can be used to decrypt the virtual function table pointer of the newly constructed object. Since objects share encryption keys, the objects of different types can be exploited for the use-after-free attacks.

The single key vulnerability can be mitigated by diversifying the encryption keys. A new key can be assigned for each class or object. Since the execution time under multi-key scheme would increase, it is necessary to maintain a balance between security and performance. In view of the above, there is a need for efficient methods and systems for encryption of virtual function table pointers.

### SUMMARY

According to aspects illustrated herein, a system for encryption of virtual function table pointers is disclosed. The system includes a control unit, a memory management unit, a memory unit, a random key generation unit, and a key storage unit. The control unit is configured to issue commands for generating an ID of a class and a key for encryption of a virtual function table pointer. The memory management unit is configured to receive a command from the control unit and generate the class ID. The memory unit is configured to receive a class name and generated class ID from the memory management unit and store the class name and the class ID in a class ID table. The random key generation unit is configured to receive a command from the control unit and generate an encryption key. The key storage unit is configured to further store the class ID transmitted from the memory unit and the encryption key transmitted from the random key generation unit in an encryption key table.

According to further aspects illustrated herein, a method for encrypting virtual function table pointers is disclosed. The method includes issuing a command to generate a class ID identifying a class of an object and a key for encrypting a virtual function table pointer of the class when its object is instantiated. Based on the command the class ID is generated and a class name and the class ID are stored in a class ID table. The method further includes generating an encryption key based on a command and storing the class ID and the encryption key in an encryption key table. The method further includes searching an encryption key as stored through the class ID and encrypting the virtual function table pointer. The encrypted virtual function table pointer is stored.

According to additional aspects illustrated herein, a method for decrypting virtual functional table pointers is disclosed. The method includes receiving an encrypted virtual function table pointer and a class ID stored in a memory unit when a virtual function is invoked. The method further includes searching an encryption key using the class ID and decrypting the encrypted virtual function table pointer using the encryption key.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a block diagram of a system for encryption of virtual function table pointers, in accordance with an embodiment of the present subject matter.

FIG. 2 illustrates a flowchart of a method for encryption of virtual function table pointers, in accordance with an embodiment of the present subject matter.

FIG. 3 illustrates a flowchart of a method for decryption of virtual function table pointers, in accordance with an embodiment of the present subject matter.

FIG. 4 illustrates a block diagram of a memory unit, in accordance with an embodiment of the present subject matter.

FIG. 5 illustrates a block diagram of a key storage unit, in accordance with an embodiment of the present subject matter.

FIG. 6 illustrates a block diagram of a search method for cryptographic key, in accordance with some embodiments.

FIG. 7 illustrates a flowchart of a search method for cryptographic key, in accordance with some embodiments.

### DETAILED DESCRIPTION

Systems and methods for encryption of virtual function table pointers are disclosed. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

Although the present disclosure has been described with the purpose of performing the encryption of virtual function table pointers, it should be appreciated that the same has been done merely to illustrate the disclosure in an exemplary manner and any other purpose or function for which explained structures or configurations could be used is covered within the scope of the present disclosure.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any element developed that performs the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored,and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory or memory devices.

Throughout the present disclosure, when a part is “connected” with another, the connection includes “indirect connection” as well as “direct connection.” Also, when a part includes a “component,” the inclusion does not imply exclusion of other components as long as the other components cause conflict. Rather, the inclusion implies the existence of additional components.

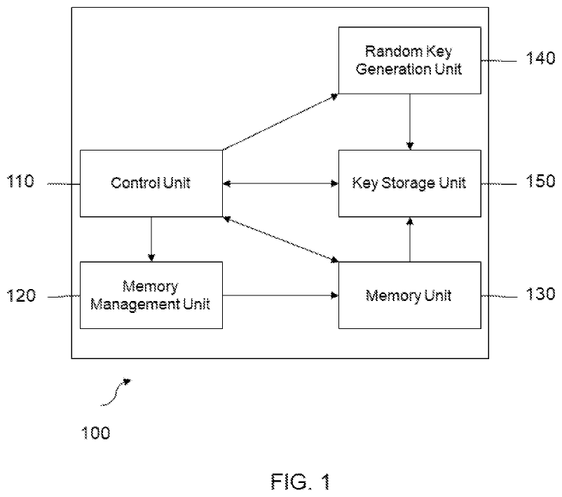

Typically, when a virtual function is defined in a class, a C++ compiler generates a virtual function table. When an object of the class is instantiated, the object includes the virtual function table pointer to the table. The present disclosure discloses methods and systems for encryption of such virtual function table pointers to defend programs against outside attacks, compromising the virtual function table pointers. More implementation, functional and structural details are discussed in FIGS. 1-7.

The aim of the present subject matter is to prevent virtual function table pointers from attacks. As an instance, the subject matter defends the virtual function table pointers against the attacks that compromise the table pointer exploiting the weakness of use-after-free. In order to do this, the subject matter encrypts virtual function table pointers of objects using the keys distinguished from others depending on the classes to which the objects belong. The encryption of the virtual function table pointers is performed such that balance between performance and security is maintained.

For a person skilled in the art, it is understood that methods and systems discussed below are exemplary in nature and are discussed only for easy understanding. There can be more modifications, additions, to the disclosed subject matter.

FIG. 1 illustrates a block diagram of a system (100) for encryption of virtual function table pointers, in accordance with an embodiment of the present subject matter. As illustrated in FIG. 1, the system 100 includes a control unit (110), a memory management unit (120), a memory unit (130), a random key generation unit (140), and a key storage unit (150). These components 110-150 work in tandem with each other to implement the present disclosure and further may be embodied in the form of hardware, software or a combination thereof. The control unit (110) issues commands for generating a class ID identifying a class and a key for encryption of a virtual function table pointer when an object is instantiated, the memory management unit (120) receives the command from the control unit (110) and generates the class ID representing a class, the memory unit (130) receives the class name and its generated class ID from the memory management unit (120) and stores the class name and its generated class ID into the class ID table, the random key generation unit (140) receives the command from the control unit (110) and generates an encryption key, and the key storage unit (150) stores the class ID transmitted from the memory unit (130) and encryption key received from the random key generation unit (140) in the encryption key table.

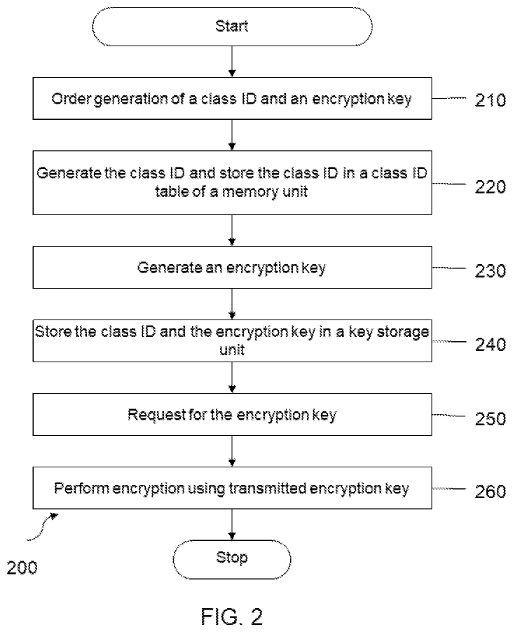

FIG. 2 illustrates a flowchart 200 of a method for encryption of virtual function table pointers, in accordance with an embodiment of the present subject matter. While discussing FIG. 2, reference to other figures may be made. The method begins with instantiation of an object. At 210, an order or a command, to generate a class ID and an encryption key is sent. The step is performed by the control unit (110). At 220, based on the command, the class ID is generated and is further stored in a class ID table of the memory unit (130). The step is performed by the memory management unit (120). According to an exemplary embodiment, the generated class ID may be 32-bit class ID.

At 230, an encryption key is generated, and this is done by the random key generation unit (140). The encryption key may be 64 random bits.

At 240, the class ID and the encryption key are stored in the key storage unit (150). At 250, the encryption key is requested and finally encryption is performed using the transmitted encryption key at 260. The steps 250 and 260 are performed by the control unit (110). The memory unit (130) stores the virtual function table pointer encrypted by the control unit (110). By encrypting the virtual function table pointer through the described method, the attacks compromising the virtual function table pointer can be defeated, and the balance between security and performance can be achieved.

As shown in FIGS. 1 and 2, if an object is instantiated, the control unit (110) commands the memory management unit (120) to generate a unique class ID denoting the class. Also, the control unit (110) orders the random key generation unit (140) to produce a key (also referred to as an encryption key or a cryptographic key) to encrypt the virtual function table pointer. The memory management unit (120) receives the orders from the control unit (110), generates the class ID and stores it with the class name into the class ID table in the memory unit (130). The generated class ID and encryption key are stored in the key storage unit (150). The control unit (110) requests the encryption key to the key storage unit (150) to encrypt the virtual function table pointer. The control unit (110) sends the class ID received from the memory unit (130) to the key storage unit (150), which sends back the encryption key. The control unit (110) encrypts the virtual function table pointer using the received encryption key in the key storage unit (150) received by referencing the class ID. The control unit (110) stores the encrypted virtual function table pointer in the memory unit (130). In this manner, the encryption of the virtual function table pointer is achieved.

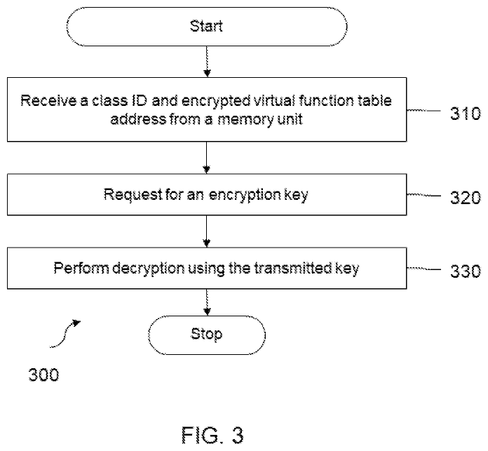

FIG. 3 illustrates a flowchart 300 of a method for decryption of virtual function table pointers, in accordance with an embodiment of the present subject matter. The method is implemented with respect to when a virtual function table pointer is already encrypted using the flowchart of FIG. 2. While discussing FIG. 3, reference to other figures may be made.

The method begins with where a virtual function is called. At 310, a class ID and an encrypted virtual function table address are retrieved or received from the memory unit (130). At 320, an encryption key is requested. Finally, decryption is performed using the transmitted encryption key at 330. In this manner, the decryption of virtual function table pointer is performed.

As shown in FIG. 3, if a virtual function is invoked, the control unit (110) receives the encrypted virtual function table address and class ID from the memory unit (130). The memory unit (130) resolves the class ID by using the class name in the class ID table. Thereafter, the control unit (110) sends the class ID to the key storage unit (150), which, in turn, sends back the encryption key to the control unit (110). Then, the control unit (110) decrypts the encrypted virtual function table pointer.

According to an embodiment of the present disclosure, its features include the control unit (110) which receives a virtual function table pointer and a class ID matching to its name from the class ID table in the memory unit (130); and further the control unit (110) searches the encryption key stored in the key storage unit (150) using the class ID; and finally the control unit (110) receives the cryptographic key and decrypts the virtual function table pointer.

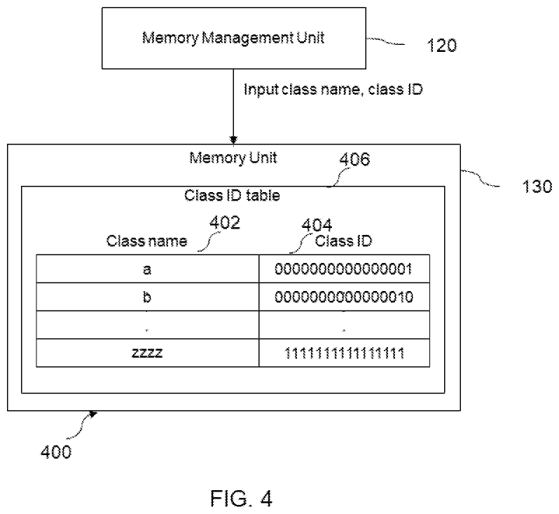

FIG. 4 illustrates a block diagram 400 of the memory unit (130) according an embodiment of the present disclosure. While discussing FIG. 4, reference to other figures may be made. The memory unit (130) stores a pair of a class name (indicated as column 402) and its ID (indicated as column 404) generated by the memory management unit (120) in the class ID table (indicated as 406). An encryption key for encryption or decryption of a virtual function pointer table is retrieved from the key storage unit (150) using the class ID.

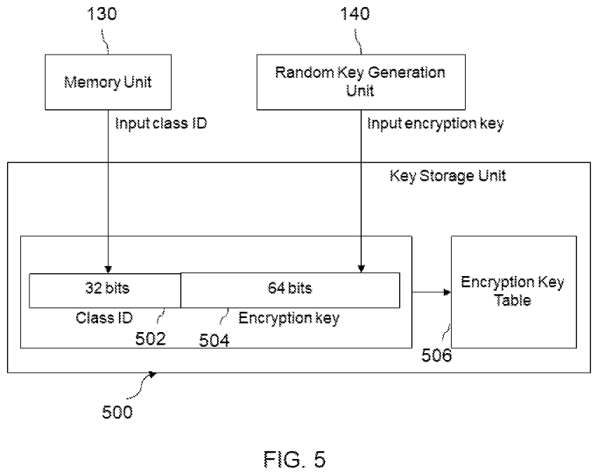

FIG. 5 illustrates a block diagram 500 of the key storage unit (150) according to an embodiment of the present disclosure. While discussing FIG. 5, reference to other figures may be made. The key storage unit (150) stores the class ID (indicated as 502) and encryption/cryptographic key (indicated as 504) in the encryption key table (indicated as 506). The class ID may be of 32-bits as indicated and the cryptographic key may be of 64-bits. The class ID which the memory management unit (120) produces with the command of the control unit (110) consists of 32 bits, and it is stored in the class ID table in the memory unit (130) and the encryption key table in the key storage unit (150). The 64-bit random cryptographic key is generated by the random key generation unit (140) with the command of the control unit (110) and stored in the key storage unit (150).

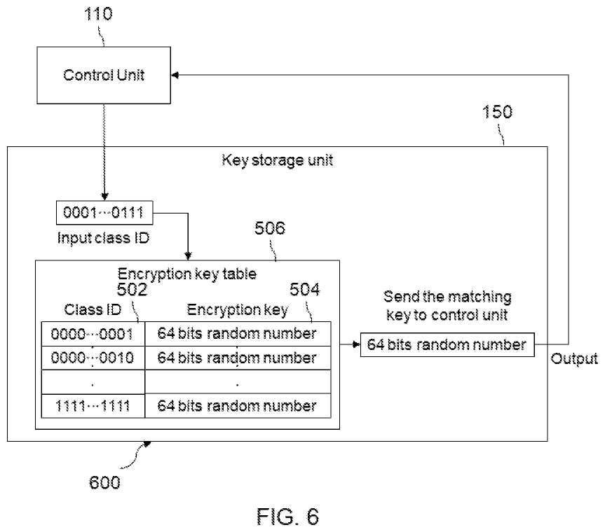

FIG. 6 illustrates a diagram 600 of an instance of cryptographic key search method according to some embodiments of the present disclosure. While discussing FIG. 6, reference to other figures may be made. As shown in FIG. 6, the control unit (110) receives the class ID matching to it name using the class ID table stored in the memory unit (130) and sends the class ID to the key storage unit (150). The key storage unit (150) compares the received class ID with the stored IDs in the key table (indicated as 506). The key storage unit (150) sends the matching key to the control unit (110).

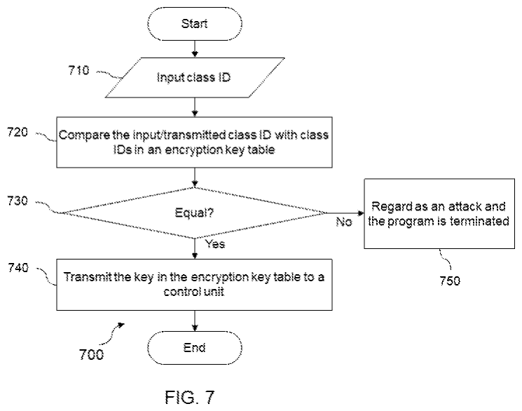

FIG. 7 illustrates a flowchart 700 of a method searching for a cryptographic key, according to an embodiment of the present disclosure. While discussing FIG. 7, reference to other figures may be made.

At 710, a class ID is input. At 720, the transmitted class ID is compared with class IDs in the encryption key table (indicated as 506). At 730, it is checked if the transmitted class ID and searched the class ID are equal. If yes, at 740, the key in the encryption key table (indicated as 506) is transmitted to the control unit (110). Else at 750, it is regarded as an attack by the key storage unit (150) and the program is terminated.

As shown in FIG. 7, the method searching for a cryptographic key in the key storage unit (150) begins with receiving a class ID from the control unit (110) and compares the class ID with the IDs stored in the encryption key table (indicated as 506). If the transmitted class ID matches to the ID of an entry stored in the key table (indicated as 506), the corresponding key is sent back to the control unit (110). Otherwise, the program is terminated since there is no matching key, and this failure of search can be regarded as a case of an attack.

According to an exemplary embodiment of the present subject matter, the system 100 follows the sequential steps for implementing, in which the control unit (110) orders generation of the class ID representing the class and an encryption key for the virtual function table pointer of an object when the object is instantiated; Step 2 in which the memory management unit (120) receives the orders from the control unit (110) and generates a class ID; Step 3 in which the memory unit (130) stores the class name and ID transmitted from memory management unit(120); Step 4 in which the random key generation unit (140) receives the order from the control unit (110) and generates an encryption key; Step 5 in which the key storage unit (150) stores the transmitted class ID and random key in the encryption key table; Step 6 in which the control unit (110) performs the encryption of the virtual function table pointer using the encryption key in the key storage unit (150) received by referencing the class ID; and Step 7 in which the control unit (110) stores the encrypted virtual function table pointer in the memory unit (130). Other variations may also be implemented.

According to an embodiment of the present subject matter, the control unit (110) features the following sequence: the control unit (110) transmits the class ID matching to its name in the memory unit (130) to the key storage unit (150). The key storage unit (150) delivers the encryption key searched by using the class ID to the control unit (110). The control unit (110) encrypts or decrypts the virtual function table pointer by using the received encryption key.

The present subject matter discloses methods and systems for encryption of virtual function table pointers. The methods and systems defend the virtual function table pointers against the attacks, corrupting the virtual function table pointers. The methods and systems maintain balance between performance and security at a proper level by assigning a cryptographic key for each class and encrypting the virtual function table pointers.

The systems and methods as described in the present disclosure or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the method of the present disclosure.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include one or more commands that instruct the processing machine to perform specific tasks that constitute the method of the present disclosure. The set of instructions may be in the form of a software program. Further, the software may be in the form of a collection of separate programs, a program module with a larger program or a portion of a program module, as in the present disclosure. The software may also include modular programming in the form of object-oriented programming. The processing of input data by the processing machine may be in response to user commands, results of previous processing or a request made by another processing machine.

For a person skilled in the art, it is understood that these are exemplary case scenarios and exemplary snapshots discussed for understanding purposes, however, many variations to these can be implemented in order to encrypt virtual function table pointers.

In the drawings and specification, there have been disclosed exemplary embodiments of the present disclosure. Although specific terms are employed, they are used in a generic and descriptive sense only and not for purposes of limitation, the scope of the present disclosure being defined by the following claims. Those skilled in the art will recognize that the present disclosure admits of a number of modifications, within the spirit and scope of the inventive concepts, and that it may be applied in numerous applications, only some of which have been described herein. It is intended by the following claims to claim all such modifications and variations which fall within the true scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure.

What is claimed is:

1. A system for encryption of virtual function table pointers, the system comprising:
a control unit configured to issue commands for generating an ID of a class and a key for encryption of a virtual function table pointer;
a memory management unit configured to:
receive a command from the control unit; and
generate a class ID;
a memory unit configured to:
receive a class name and generated class ID from the memory management unit; and
store the class name and the generated class ID in a class ID table;
a random key generation unit configured to:
receive a command from the control unit; and
generate an encryption key; and
a key storage unit configured to store the class ID transmitted from the memory unit and the encryption key transmitted from the random key generation unit in an encryption key table.

2. The system according to claim 1, wherein the memory management unit is further configured to generate 32-bit class IDs.

3. The system according to claim 1, wherein the random key generation unit is further configured to generate the encryption key comprising of 64-bit random numbers.

4. The system according to claim 1, wherein the control unit is further configured to search an encryption key stored in the key storage unit by using the class ID stored in the memory unit and perform encryption or decryption of the virtual function table pointer.

5. The system according to claim 4, wherein the memory unit is configured to store the virtual function table pointer encrypted by the control unit.

6. A method for encrypting virtual function table pointers, the method comprising:
issuing a command to generate an ID identifying a class of an object and a key for encryption of a virtual function table pointer of the class when the object is instantiated;
generating a class ID based on the command;
storing a class name and the class ID in a class ID table;
generating an encryption key based on a command;
receiving the class ID and the encryption key and storing the class ID and the encryption key in an encryption key table;
searching the encryption key as stored in the encryption key table through the class ID and encrypting the virtual function table pointer; and
storing the encrypted virtual function table pointer.

7. The method according to claim 6, further comprising generating 32-bit class IDs.

8. The method according to claim 6, further comprising generating 64-bit random number keys.

9. The method according to claim 6, further comprising searching an encryption key stored in the key storage unit by using the class ID stored in the memory unit and performing encryption or decryption of the virtual function table pointer.

10. The method according to claim 9, further comprising storing the virtual function table pointer.

11. A method for decrypting virtual functional table pointers, the method comprising:
receiving an encrypted virtual function table pointer and a class ID stored in a memory unit when a virtual function is invoked;
searching an encryption key stored in a key storage unit using the class ID;
receiving the encryption key; and
decrypting the encrypted virtual function table pointer.

12. The method according to claim 11, further comprising generating 32-bit class IDs.

13. The method according to claim 11, further comprising generating 64-bit random number keys.
